(19) United States
(12) Patent Application Publication
(10) Pub. No.: US 2024/0330876 A1
(43) Pub. Date: Oct. 3, 2024

(54) CORRESPONDENCE DATA HUB

(71) Applicant: Bank of America Corporation, Charlotte, NC (US)

(72) Inventors: Murali Chowdarapu, Simi Valley, CA (US); Rinken Patel, Newark, DE (US); Ryan S. Heller, Newark, DE (US); Charanjit Bagga, Thousand Oaks, CA (US); Sowdamini Tanneeru, Thousand Oaks, CA (US); Anubhav Anukool, Plano, TX (US); Saurabh Khanna, Frisco, TX (US); Sanjay Yadav, Wilmington, DE (US)

(21) Appl. No.: 18/126,521

(22) Filed: Mar. 27, 2023

(51) Int. Cl. G06Q 20/10

(52) U.S. Cl. CPC G06Q 20/10

(57) ABSTRACT

Apparatus and methods for incentivizing adoption of paperless transactions by customers through a correspondence data hub are provided. The correspondence data hub may receive incoming and outgoing communications between a customer and an entity. The correspondence data hub may pre-process the communications and convert each communication to a single format. The correspondence data hub may analyze the communications and create a correspondence plan. The correspondence plan may include one or more benefits to the customer of opting in to paperless transactions. Some or all actions by the correspondence data hub may be recorded in a database. The correspondence plan may be implemented by the correspondence data hub.

### FIELD OF TECHNOLOGY

Aspects of the disclosure relate to providing apparatus and methods to collect, combine, store, and analyze correspondence with customers, to convince customers to move to paperless correspondence.

### BACKGROUND OF THE DISCLOSURE

Entities may include individuals, corporations, partnerships, non-profits, government agencies or branches, and other groups of people. Entities may be any size, including small (one member or employee) or large (thousands of employees or members). Entities may have customers. Customers may be internal or external. Internal customers may include, inter alia, employees, vendors, disparate business units, and disparate franchises.

Many entities, especially larger entities, may have, and generate, numerous correspondence files between the entity and its customers, or about particular customers. Correspondence files may be of any supported type. Correspondence files may be incoming, outgoing, or internal. Correspondence files may be located in disparate data centers or physical storage centers. Correspondence may include transactions, such as checks and contracts.

Larger entities may have multiple different incoming and outgoing correspondence data streams (e.g., paper letters, texts, phone calls, emails, etc.).

Many entities may also prefer paperless communications and data storage to paper communications and physical storage. Paperless may be more efficient, cheaper, and more environmentally friendly. However, some customers may prefer paper communications, for record-keeping, lack of trust, or other purposes.

Currently, there is no apparatus or method available to automatically gather all correspondence between an entity and a customer in a single hub, evaluate the correspondence for approaches to convince the customer to switch to paperless, and then implement those approaches.

Therefore, it would be desirable for apparatus and methods to collect, combine, store, and analyze correspondence with customers, to encourage adoption of paperless transactions by the customers.

### SUMMARY OF THE DISCLOSURE

It is an object of this disclosure to provide apparatus and methods to collect, combine, store, and analyze correspondence between customers and entities, generate approaches to convince a customer to switch to paperless correspondence.

instructions. The executable instructions may be executed by a processor on a computer system.

When executed, the instructions may receive two or more incoming correspondence files from a customer to an entity. The instructions may receive two or more outgoing correspondence files to the customer from the entity.

The instructions may register within a working file in the program each of the two or more incoming correspondence files and each of the two or more outgoing correspondence files.

The instructions may record each registration within a database.

The instructions may transfer each of the two or more incoming correspondence files and each of the two or more outgoing correspondence files to a pre-processing folder.

The instructions may record each transfer within the database.

The instructions may pre-process each of the incoming and outgoing correspondence files. Pre-processing each correspondence file may include capturing metadata for each file.

The instructions may convert each of the incoming and outgoing correspondence files to a single format. A single format may make an analysis easier and faster, among other benefits.

The instructions may create a complete file for each of the incoming and outgoing correspondence files (a minimum of four complete files). Each complete file may include one correspondence file, one pre-processed correspondence file, and one formatted correspondence file.

The instructions may store each complete file within the database and analyze each complete file. The analysis may include evaluating a source of each incoming correspondence file, evaluating a type of each incoming correspondence file, evaluating the metadata, evaluating a location of where each incoming correspondence file was transmitted to the entity by the customer, and evaluating a date and time of transmission of each incoming correspondence file.

The instructions may create a correspondence plan between the entity and the customer. The correspondence plan may communicate one or more benefits of paperless transactions to the customer.

In an embodiment, the single format may be text.

In an embodiment, the single format may be xml.

In various embodiments, a source of each of the incoming correspondence data files may be one of: a text message; an email; a phone call; a video call; a letter; a fillable form; or a chatbot conversation. The audiovisual and physical sources may be converted to digital data, including text.

In an embodiment, the analysis may use one or more artificial intelligence/machine learning (“AI/ML”) algorithms to perform the analysis.

In an embodiment, the correspondence plan may be created by one or more artificial intelligence/machine learning (“AI/ML”) algorithms.

In an embodiment, the instructions may transmit the correspondence plan to a system administrator.

In an embodiment, the instructions may implement the correspondence plan, according to the terms of the correspondence plan.

In an embodiment, the correspondence plan may be implemented by modifying a future outgoing correspondence file.

In an embodiment, the correspondence plan may be implemented by checking all future outgoing correspondence files to the customer against the correspondence plan and ensuring the outgoing files match any parameters of the correspondence plan.

In an embodiment, when the customer agrees to one or more paperless transactions or correspondence settings, the instructions may modify the correspondence plan.

In an embodiment, the database may be encrypted.

In an embodiment, only the entity may have access to the correspondence data hub.

In an embodiment, the customer may have access to the correspondence data hub.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative apparatus in accordance with principles of the disclosure.

FIG. 4 shows an illustrative module in accordance with principles of the disclosure.

FIG. 5 shows an illustrative module in accordance with principles of the disclosure.

FIG. 6 shows an illustrative module in accordance with principles of the disclosure.

FIG. 7 shows an illustrative flowchart in accordance with principles of the disclosure.

FIG. 8 shows an illustrative apparatus in accordance with principles of the disclosure.

### DETAILED DESCRIPTION OF THE DISCLOSURE

It is an object of this disclosure to provide apparatus and methods to collect, combine, process, store, and analyze correspondence between customers and entities, generate approaches to convince a customer to switch to paperless correspondence, and implement those approaches.

A correspondence data hub computer program product is provided. The computer program product may include executable instructions. The executable instructions may be executed by a processor on a computer system.

Multiple processors may increase the speed and capability of the program. The executable instructions may be stored in non-transitory memory on the computer system or a remote computer system, such as a server.

Other standard components of a computer system may be present. The computer system may be a server, mobile device, or other type of computer system. A server or more powerful computer may increase the speed at which the computer program may run. Portable computing devices, such as a smartphone, laptop or tablet, may increase the portability and usability of the computer program, but may not be as secure or as powerful as a server or desktop computer.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The computer may include, among other components, a communication link, a processor or processors, and a non-transitory memory configured to store executable data configured to run on the processor,. The executable data may include an operating system and the correspondence data hub computer program.

A processor or processors may control the operation of the computer system and its components, which may include RAM, ROM, an input/output module, and other memory. The microprocessor(s) may also execute all software running on the apparatus and computer system. Other components commonly used for computers, such as EEPROM or Flash memory or any other suitable components, may also be part of the apparatus and computer system.

A communication link may enable communication with other computers as well as any server or servers. The communication link may include any necessary hardware (e.g., antennae) and software to control the link. Any appropriate communication link may be used, such as Wi-Fi, bluetooth, LAN, and cellular links. In an embodiment, the network used may be the Internet. In another embodiment, the network may be an internal intranet or other network.

The computer system may be a server. The computer program may be run on a smart mobile device. The computer program, or portions of the computer program may be linked to other computers or servers running the computer program. The server or servers may be centralized or distributed. Centralized servers may be more powerful and secure than distributed servers but may also be more expensive and less resilient.

When executed, the instructions may receive two or more incoming correspondence files from a customer to an entity. The instructions may also receive two or more outgoing correspondence files to the customer from the entity. The more correspondence files received, the more data the computer program may analyze, and the more accurate the computer program may be.

The correspondence files may be from any time. One or more of the correspondence files may be contemporaneous with an activation of the computer program. The correspondence files may be ‘tagged’ or have a notation associating each file with a particular customer. A tag may be added by the computer program.

The correspondence files may be located in memory of the same computer system as the computer program. The correspondence files may be located in memory of multiple computer systems. The correspondence files may be located in one or more databases. The correspondence files may be in any format. The correspondence files may be converted correspondence files. For example, an initial correspondence file may be in an audiovisual format and then converted to an alphanumeric format. The correspondence files may be any size.

In various embodiments, a source of each of the incoming correspondence data files may be one of, inter alia: a text message, an email, a phone call, a video call, a letter, a fillable form, a recorded conversation, a recorded interaction, or a chatbot conversation. The audiovisual and physical sources may be converted to digital data, including text.

Each correspondence file may correspond to any correspondence between the customer and the entity. Different entities may have different document or correspondence retention policies. Correspondence retention policies may depend on the type of correspondence. Correspondence may include transactions, contracts, records, deeds, legal documents, fillable forms, regular correspondence (email, letters, etc.), as well as any other communication between the customer and the entity, including interpersonal communication between an employee and the customer that may be recorded through sound or audiovisual methods. Correspondence may be outgoing from the entity to the customer. Correspondence may be incoming from the customer to the entity. Correspondence may be from a third-party to the entity regarding the customer.

In an embodiment, the customer may be an internal person at the entity, such as an employee, vendor, or contractor. In an embodiment, the customer may be a distinct entity apart from the entity. For example, if the entity is a financial institution, the customer may be an individual customer, an entity customer (such as a small business), an employee or contractor of the financial institution, a vendor that performs work for or with the financial institution, or another type of customer.

The computer program may create a working file for each customer or for a group of customers. The working file may be generated every time the program is run for a particular customer. In an embodiment, the program may be run for a group of customers at one time. In this embodiment, the program may create one large working file, or the program may create one working file for each customer within the group of customers.

In an embodiment, the working file may be a working folder instead of a working file. A folder may be a location (or address) on memory where the contents of the folder may reside or be located.

The instructions may register within the working file(s) in the program each of the two or more incoming correspondence files and each of the two or more outgoing correspondence files. Registering each of the correspondence files may allow the program to perform its remaining functions. Registering may include transcribing or recording data about each correspondence file, including metadata, the computer location, memory location, a log of the program's actions, as well as other information. Registering may include adding a tag or tags to each correspondence file or information about each correspondence file.

The instructions may record each registration within a database. The database may be located at or near the computer system with the computer program. The database may be located remotely from the computer system with the computer program. The database may be accessed over an internal or external network.

The instructions may transfer each of the two or more incoming correspondence files and each of the two or more outgoing correspondence files to a pre-processing folder. The pre-processing folder may include only the correspondence files. The pre-processing folder may include other files besides the correspondence files.

The instructions may record each transfer within the database. The recording may include the registration information. Recording each transfer may create a traceable log that may be analyzed or audited by the program, a different program, or a system administrator.

The instructions may pre-process each of the incoming and outgoing correspondence files. Pre-processing each correspondence file may include capturing metadata for each file. Pre-processing may include other manipulation or capturing of other data. Pre-processing may include translating from one language to another. Pre-processing may include converting analog correspondence to digital data. Pre-processing may include converting from one format to another. Pre-processing may include preparing each correspondence file for analysis. Pre-processing may include any other processing necessary for the program to function.

The instructions may convert each of the incoming and outgoing correspondence files to a single format. A single format may make an analysis easier and faster, among other benefits. In various embodiments, the single format may be text, xml, pdf, doc, docx, open-source formats, proprietary formats, or a combination of formats. For example, if one file is text, another is pdf, and a third is xml, the instructions may convert each file to text. The program may use a speech-to-text converter. The program may use an optical character recognition (OCR) module.

In an embodiment, the program may vary the conversion type within each working file. The variance may depend on various factors, including the types and amounts of each originating correspondence file type. For example, if there are ten correspondence files and eight of them are in a pdf format, the program may determine that the remaining two should be converted to pdf format to reduce the amount of conversions necessary.

In an embodiment, after conversion to a single format, the program may process (or continue to process) each file to gather data for the analysis. For example, the program may run an OCR analysis on each pdf correspondence file to make any text readable and searchable by the program.

The instructions may create a complete file or folder for each of the incoming and outgoing correspondence files (a minimum of four complete files). Each complete file or folder may be complete in the sense that it includes one correspondence file, one pre-processed correspondence file, and one formatted correspondence file. Keeping each version of each correspondence file together within one file or folder may increase the accuracy of any analysis as well as provide a more easily auditable and viewable process.

The instructions may store each complete file within the database. The database may be the same or a different database where the other logs and files are stored. In an embodiment, the database may be distributed across multiple computer systems or servers. The distributed systems or servers may be geographically distant.

The instructions may analyze each complete file. The analysis may include evaluating a source of each incoming correspondence file, evaluating a type of each incoming correspondence file, evaluating the metadata, evaluating a location of where each incoming correspondence file was transmitted to the entity by the customer, evaluating the contents of each incoming and outgoing correspondence, and evaluating a date and time of transmission of each incoming correspondence file. The analysis may include evaluating any other information included with each correspondence file, including the topic of the correspondence, the amount of each type of correspondence, the total amount of correspondence, and other factors.

Each factor may be analyzed on a scale. The scale may be of any type. For example, the scale may be a number from 0 through 10, with 10 being most likely to adopt paperless and 0 being least likely to adopt paperless. The scale may be adjusted dynamically by the program. The scale may be adjusted manually.

The instructions may create a correspondence plan between the entity and the customer. The correspondence plan may be configured to communicate one or more benefits of paperless transactions and communications to the customer. The correspondence plan may include exemplary actions for the entity to undertake to attempt to convince the customer to convert to paperless transactions and communications. For example, the plan may include sending one or more informational brochures/documents, paper or electronic, to the customer describing benefits of paperless transactions. The plan may include displaying a pop-up informational screen to the customer at various, but described in the plan, times. The plan may include always providing the option of paperless transactions/documents to the customer first, before continuing any interaction with the customer. The correspondence plan may include multiple action items for the entity (or program automatically) to implement.

The correspondence plan may include a graphical display option to present to the customer wherein the customer may select the option of moving to paperless. The graphical display may include a hyperlink, a checkbox, a signature line, or other graphical display elements. The plan may include when, where, and how often to display the graphical display option. The graphical display option may also include a location where the customer may opt out of paperless, as well as opt out of communications to move to paperless.

The correspondence plan may include a duration, a start time, and an end time. For example, the program may determine that the items or actions in the correspondence plan should last for one month. After that month, in an embodiment, the program may automatically re-evaluate the customer's correspondence files, with an emphasis on the most recent correspondence files, to fine-tune, change, or abandon the correspondence plan.

In an embodiment, the analysis may use one or more artificial intelligence/machine learning (“AI/ML”) algorithms to perform the analysis. Any suitable AI/ML algorithms may be used. Each algorithm may dynamically evaluate one or more factors in its analysis. The algorithm(s) may iterate. The algorithm(s) may be trained on a training set of data. The training set may be created data or actual data. The algorithms may be checked by one or more system administrators.

In an embodiment, the correspondence plan may be created by one or more artificial intelligence/machine learning (“AI/ML”) algorithms. Any suitable AI/ML algorithms may be used. Each algorithm may dynamically evaluate one or more factors in its analysis and creation of the correspondence plan. The algorithm(s) may iterate. The algorithm(s) may be trained on a training set of data. The training set may be created data or actual data. The algorithms may be checked/audited by one or more system administrators.

In an embodiment, the instructions may transmit the correspondence plan to a system administrator. The system administrator may review the correspondence plan. The system administrator may implement or begin to implement the correspondence plan.

In an embodiment, the instructions may automatically implement the correspondence plan, according to the terms of the correspondence plan. For example, if the correspondence plan includes sending an informational document or invitation to the customer, the instructions may automatically create that document or invitation and transmit it to the customer. When the correspondence plan includes presenting a graphical display option to customer wherein the customer may select paperless communications, the instructions may automatically create that graphical display option as well as display that graphical display option to the customer.

In an embodiment, the correspondence plan may be implemented by modifying a future outgoing correspondence file. The modification may be automatic. The modification may include appending to the outgoing correspondence file a separate page or document that explains paperless options to the customer and invites the customer to adopt paperless. The future outgoing correspondence file may be electronic or paper.

In an embodiment, the correspondence plan may be implemented by checking all future outgoing correspondence files to the customer against the correspondence plan and ensuring the outgoing files match any parameters of the correspondence plan. For example, if a parameter of the correspondence plan states that the first page or sentence of any outgoing correspondence should include an invitation to the customer to adopt paperless communications/transactions, the program may check every outgoing correspondence file (electronic or paper) to determine if each includes that page or statement. If the determination is no, the program may automatically insert appropriate language to match the correspondence plan. If the determination is yes, the program may release the outgoing correspondence file for transmission to the customer. Transmission may include mail, e-mail, etc.

In an embodiment, when the customer agrees to one or more paperless transactions or correspondence settings, the instructions may modify the correspondence plan. The instructions may continuously, or at specified intervals (e.g., every day, every week, every month, etc.) monitor all incoming and outgoing correspondence. For example, if the correspondence plan includes a parameter that every outgoing correspondence file include an invitation to the customer to adopt paperless communications, once the customer does adopt paperless communications, there would be no need to continue inviting the customer to adopt paperless communications. At this point the program may modify the correspondence plan to remove any redundant or unnecessary parameters.

In an embodiment, the database may be encrypted. Encrypting the database may be required depending on the sensitivity of the data or correspondence files. Any appropriate encryption protocol or method may be used.

In an embodiment, only the entity may have access to the correspondence data hub. In this embodiment, the correspondence data hub may be solely an internal application or process of the entity that may not be accessible by customers.

In an embodiment, the customer may have access to the correspondence data hub. In this embodiment, both the customer and the entity may have access to all or part of the correspondence data hub. In this embodiment, any customer facing functionality may use the same or a different user interface than internal (to the entity) only functionality.

An apparatus for a correspondence data hub is provided. The apparatus may include a central server. The central server may include a communication link, a processor, and a non-transitory memory. The non-transitory memory may be configured to store, among other things, a server operating system and a correspondence data hub application.

The correspondence data hub application may include functions, modules, or processes referred to as: an integrated data sourcing and provisioning module, an automatic data quality check module, and an integrated actionable insight module.

The integrated data sourcing and provisioning module may be configured to receive two or more incoming correspondence files from a customer to an entity, receive two or more outgoing correspondence files to the customer from the entity, register each of the two or more incoming correspondence files and each of the two or more outgoing correspondence files, record each registration within a database, transfer each of the two or more incoming correspondence files and each of the two or more outgoing correspondence files to the automatic data quality check module, and record each transfer within the database.

The automatic data quality check module may be in-line or in a different configuration. The automatic data quality check module may be configured to pre-process each of the incoming and outgoing correspondence files, convert each of the incoming and outgoing correspondence files to a single format, create a complete file for each of the incoming and outgoing correspondence files, and store each complete file within the database.

The integrated actionable insights module may be configured to analyze each complete file, and create a correspondence plan between the entity and the customer based on the analysis.

In an embodiment, the integrated actionable insights module may include one or more artificial intelligence/machine learning (“AI/ML”) algorithms.

In an embodiment, the correspondence plan may include one or more benefits to the customer of opting in to paperless transactions.

In an embodiment, the correspondence plan may be automatically implemented by the correspondence data hub application.

A method for incentivizing a customer to opt in to paperless transactions is provided. The method may include the step of receiving, at an integrated data sourcing and provisioning module of a correspondence data hub application on a centralized server, two or more incoming correspondence files from the customer to an entity.

The method may include the step of receiving, at the integrated data sourcing and provisioning module, two or more outgoing correspondence files to the customer from the entity.

The method may include the step of registering, by the integrated data sourcing and provisioning module, each of the two or more incoming correspondence files and each of the two or more outgoing correspondence files.

The method may include the step of recording, at a database, each registration.

The method may include the step of transferring each of the two or more incoming correspondence files and each of the two or more outgoing correspondence files from the integrated data sourcing and provisioning module to an automatic data quality check module of the correspondence data hub application.

The method may include recording, by the correspondence data hub application each transfer within the database.

The method may include pre-processing, at the automatic data quality check module, each of the incoming and outgoing correspondence files.

The method may include the step of converting, at the automatic data quality check module, each of the incoming and outgoing correspondence files to a single format.

The method may include the step of creating, at the automatic data quality check module, a complete file for each of the incoming and outgoing correspondence files. Each complete file may include one correspondence file, one pre-processed correspondence file, and one formatted correspondence file.

The method may include the step of storing each complete file within the database.

The method may include the step of analyzing, at an integrated actionable insights module of the correspondence data hub application, each complete file.

The method may include the step of creating, at the integrated actionable insights module, a correspondence plan between the entity and the customer. The correspondence plan may include one or more benefits to the customer of opting in to one or more paperless transactions. The correspondence plan may include a graphical display option wherein the customer can select an option of moving to paperless communications and transactions.

The method may include the step of automatically implementing, by the correspondence data hub application, the correspondence plan.

In an embodiment, the database may be located away from the central server.

In an embodiment, the correspondence data hub application may use uses one or more artificial intelligence/machine learning (“AI/ML”) algorithms in the steps of: analyzing, at the integrated actionable insights module, each complete file; creating, at the integrated actionable insights module, a correspondence plan between the entity and the customer; and automatically implementing, by the correspondence data hub application, the correspondence plan.

In an embodiment, the customer may be granted access to the correspondence data hub application by a system administrator.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

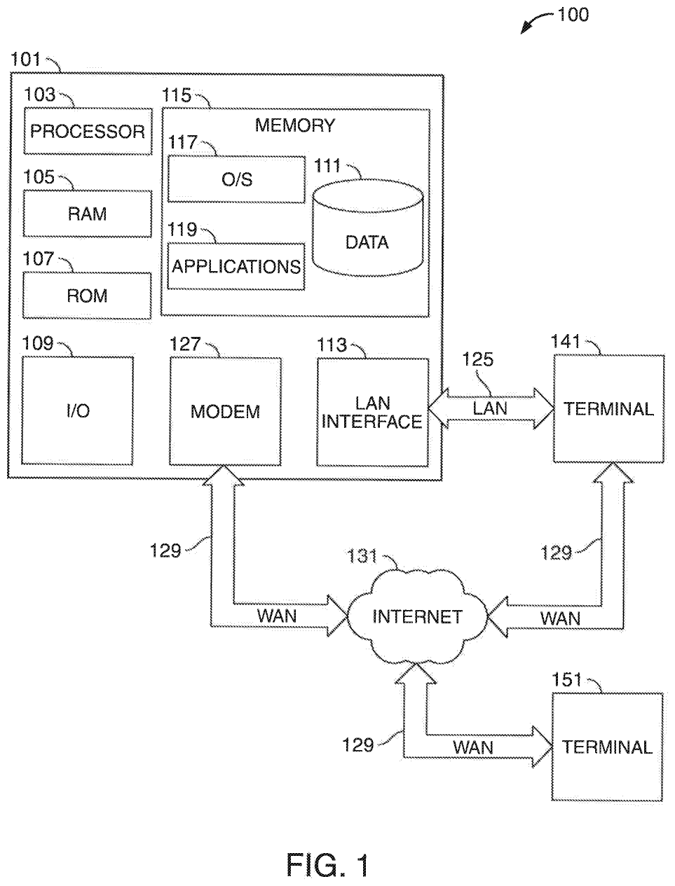

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as a correspondence data hub and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as a correspondence data hub and security protocols) along with any other data 111 (e.g., historical data, configuration file) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as a correspondence data hub and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for a correspondence data hub and security protocols, as well as other programs. In an embodiment, one or more programs, or aspects of a program, may use one or more AI/ML algorithm(s). The various tasks may be related to gathering and analyzing correspondence files and generating a correspondence plan to incentivize paperless transaction and communication adoption.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

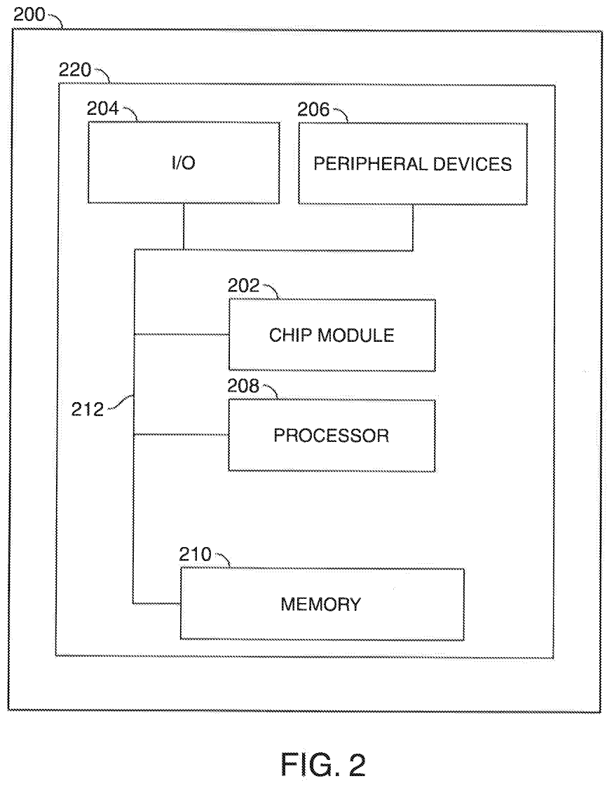

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

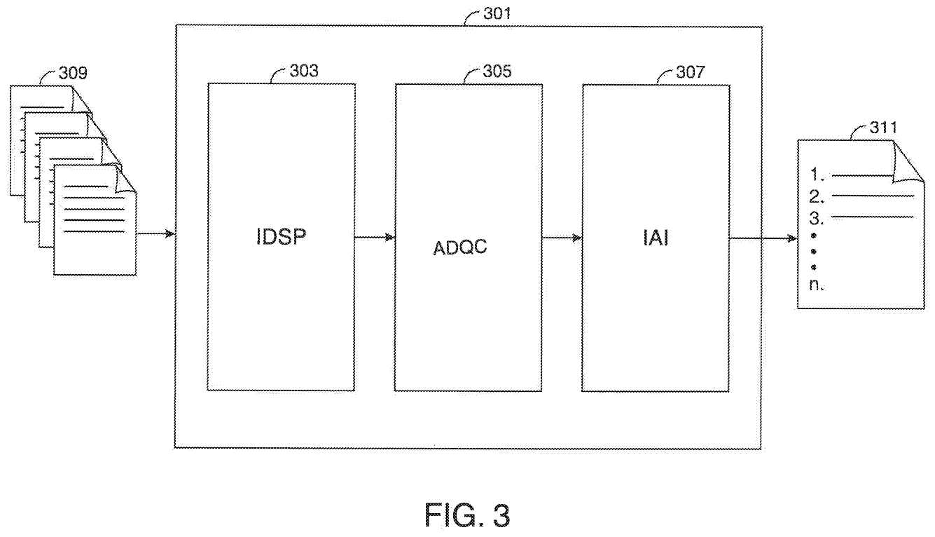

FIG. 3 shows an illustrative apparatus in accordance with principles of the disclosure. Apparatus may include any of the components and systems odd-numbered 301 through 311, among other components.

A correspondence data hub 301 may include, inter alia, an integrated data sourcing and provisioning (IDSP) module 303, an automated (in-line) data quality check module (AIDQC or ADQC) 305, and an integrated actionable insights (IAI) module 307.

Correspondence files 309 may be received by the correspondence data hub 301. The correspondence data hub 301 may produce a correspondence plan 311.

The IDSP module 303 may be configured to receive correspondence files 309, incoming from a customer to an entity and outgoing to the customer from the entity, register each of the correspondence files 309, record each registration within a database, and transfer each correspondence file to the AIDQC 305, and record each transfer within a database (not shown).

The AIDQC module 305 may be configured to pre-process each of the correspondence files 309, convert each of the correspondence files 309 to a single format, create a complete file for each of the correspondence files 309, and store each complete file within the database.

The IAI module 307 may be configured to analyze each complete file and create a correspondence plan 309 between an entity and a customer based on the analysis.

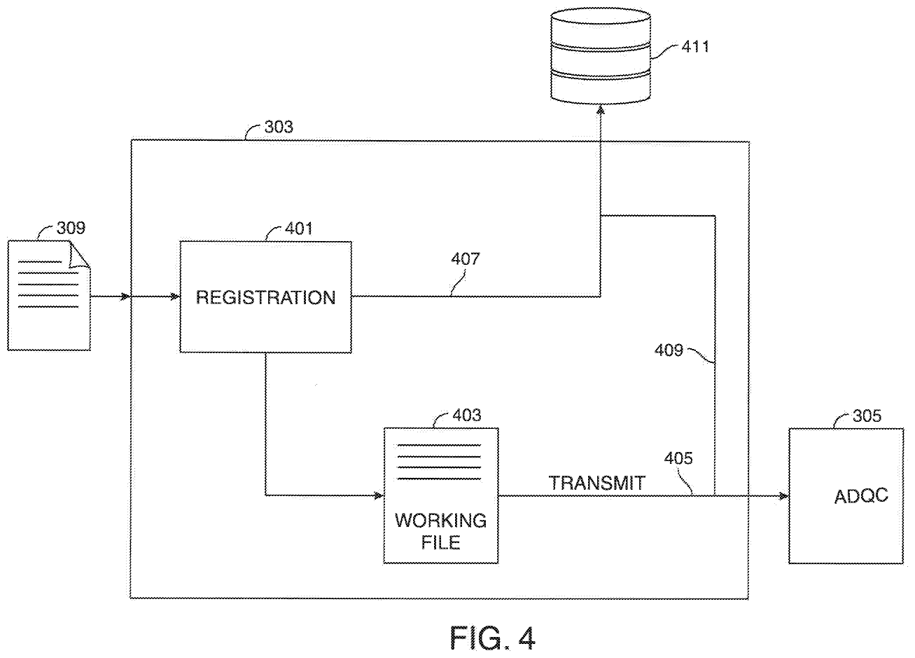

FIG. 4 shows an illustrative module in accordance with principles of the disclosure.

IDSP module 303 within correspondence data hub 301 may receive correspondence files 309. Module 303 may register 401 each correspondence file 309. The registration 401 may be recorded 407 in a database 411.

Module 303 may create a working file 403 for each correspondence file 309. Each working file 403 may be transmitted 405 to the AIDQC 305. Each transmission 405 may be recorded 409 in the database 411.

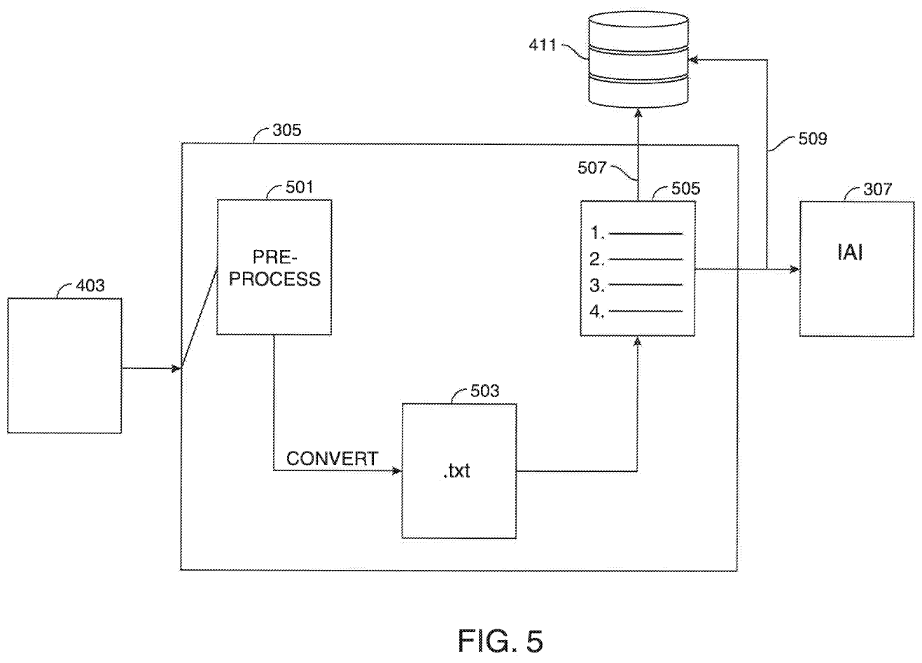

FIG. 5 shows an illustrative module in accordance with principles of the disclosure.

AIDQC module 305 within correspondence data hub 301 may receive one or more working files 403 from the IDSP module 303. The AIDQC module 305 may pre-process 501 each working file 403.

The AIDQC module 305 may then convert each pre-processed file to a single format 503, such as txt, pdf, xml, etc.

The AIDQC module 305 may create a complete file 505, which may include the original correspondence files, the working file 403, the converted file 503, and other files.

The complete file 505 may be recorded 507 in the database 411.

The complete file 505 may be transmitted to the IAI module 307. The transmission may be recorded 509 in the database 411.

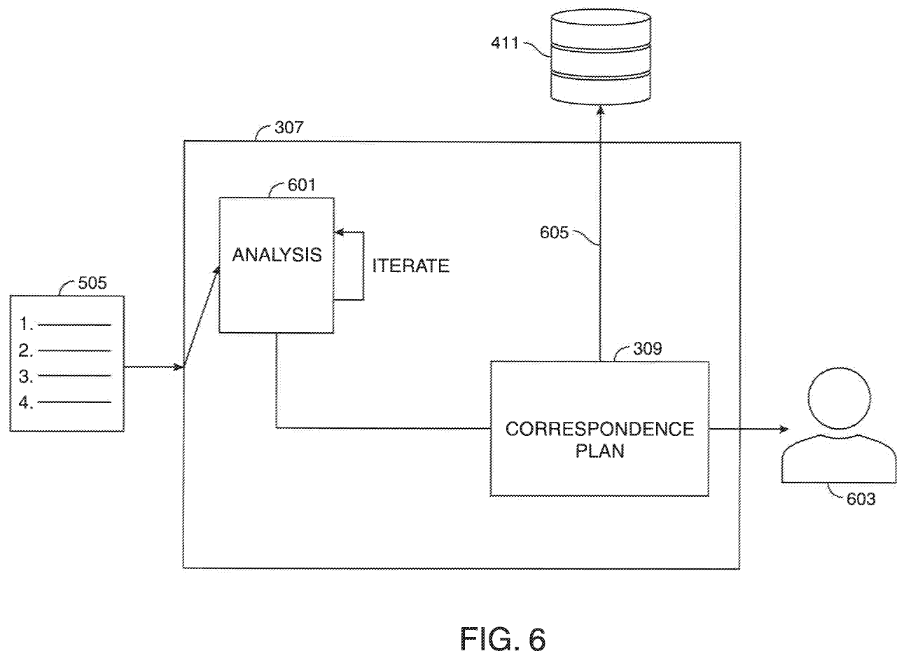

FIG. 6 shows an illustrative module in accordance with the principles of the disclosure.

IAI module 307 withing correspondence data hub 301 may receive each complete file 505 from the AIDQC module 305.

The IAI module 307 may analyze 601 each complete file 505. The analysis 601 may be iterated. The analysis 601 may utilize one or more AI/ML algorithms.

After the analysis 601, the IAI module 307 may create a correspondence plan 309. The correspondence plan 309 may be record 605 in the database 411.

The correspondence plan 309 may be transmitted to a system administrator or user 603 for review and implementation. In an embodiment, the correspondence data hub 301 may implement the correspondence plan 309 automatically.

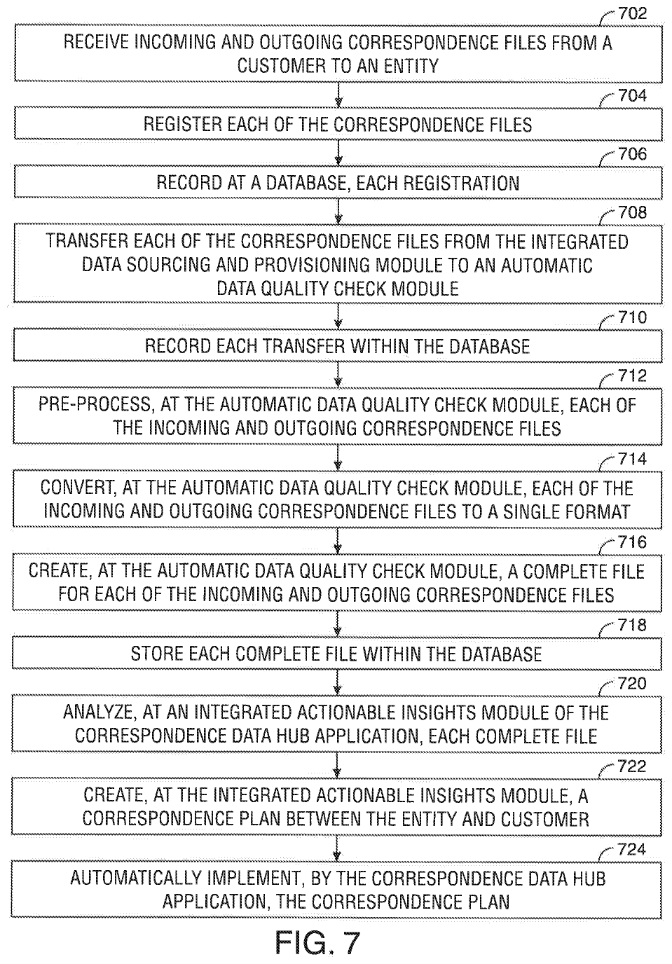

FIG. 7 shows an illustrative flowchart in accordance with principles of the disclosure. Methods may include some or all of the method steps numbered 702 through 724. Methods may include the steps illustrated in FIG. 7 in an order different from the illustrated order. The illustrative method shown in FIG. 7 may include one or more steps performed in other figures or described herein. Steps 702 through 724 may be performed on the apparatus shown in FIGS. 1-8 or other apparatus.

At step 702, an integrated data sourcing and provisioning (“IDSP”) module of a correspondence data hub application on a server, centralized or decentralized, may receive two or more incoming correspondence files from a customer to an entity, and receive two or more outgoing correspondence files from the entity to the customer.

At step 704, the IDSP module may register each of the correspondence files. Registering may include creating a working file for each correspondence file or each customer. Registering may include mining each file for particular data required for additional steps.

At step 706, the IDSP module or the correspondence data hub may record the registration of each file at a database. The database may be proximate or distant from the server.

At step 708, the IDSP module may transfer each correspondence file to an automatic data quality check module (“ADQC” or “AIDQC”) of the correspondence data hub. The IDSP may also transfer the registered files and the working files.

At step 710, each transfer may be recorded in the database. Recording each transfer may increase the auditability, accessibility, and ability to modify the correspondence data hub.

At step 712, the ADQC may pre-process each of the correspondence files.

At step 714, the ADQC may automatically convert each correspondence file to a single format, such as txt, pdf, xml, etc. A single format may increase the ability of the correspondence data hub to analyze the correspondence files. The ADQC may use speech-to-text and OCR methods to convert each correspondence file, as necessary.

At step 716, the ADQC may create a complete file for each correspondence file. The complete file may include a correspondence file, a pre-processed correspondence file, a formatted correspondence file, as well as other information required by the correspondence data hub to analyze the correspondence files.

At step 718, each complete file may be stored within the database. In addition, the ADQC may transfer or transmit each complete file to an integrated actionable insights (“IAI”) module of the correspondence data hub.

At step 720, the IAI module may analyze each complete file. The IAI module may look at and analyze each complete file to determine various factors about the customer's ability and willingness to adopt paperless transactions and communications. In an embodiment, the IAI module may use AI/ML algorithms to perform its analysis.

At step 722, the IAI module may create a correspondence plan between the entity and the customer. The correspondence plan may include one or more benefits to the customer of opting into paperless transactions and communications. The correspondence plan may include one or more steps for the entity to implement that may demonstrate the benefits of paperless transactions and communications to the customer. The benefits may include rewards (such as loyalty points or discounts) provided by the entity. The plan may include information to be presented to the customer. The plan may include providing an option to the customer to opt into paperless transactions and communications. The correspondence plan may include a graphical display option to display to the customer wherein the customer can select paperless. The plan may be time, date, and correspondence type limited.

At step 724, the correspondence data hub may automatically implement the correspondence plan. In an embodiment, the correspondence data hub may transmit the plan to a system administrator of the entity for review and implementation.

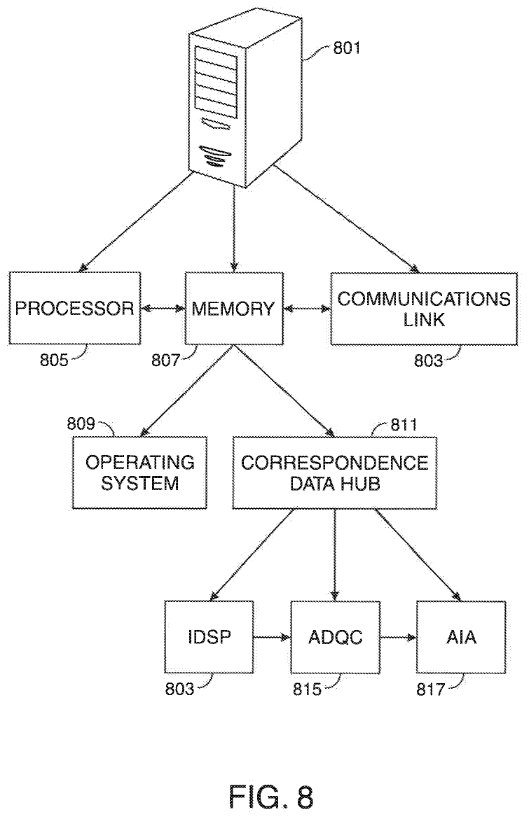

FIG. 8 shows an illustrative apparatus in accordance with principles of the disclosure. A server/computer 801 may include a communication link 803, a processor/processors 805, and a non-transitory memory 807, as well as other components.

The non-transitory memory 807 may include an operating system 809, and a correspondence data hub application 811, as well as other data and programs.

The correspondence data hub application 811 may include an integrated data sourcing and provisioning module 813, an automatic data quality check module 815, an integrated actionable insight module 817, as well as other data and modules.

The integrated data sourcing and provisioning module 813 may be configured to receive two or more incoming correspondence files from a customer to an entity, receive two or more outgoing correspondence files to the customer from the entity, register each of the correspondence files, record each registration within a database, transfer each of the correspondence files to the automatic data quality check module 815, and record each transfer within the database.

The automatic data quality check module 815 may be configured to pre-process each of the incoming and outgoing correspondence files, convert each of the incoming and outgoing correspondence files to a single format, create a complete file for each of the incoming and outgoing correspondence files, and store each complete file within the database.

The integrated actionable insights module 817 may be configured to analyze each complete file and create a correspondence plan between the entity and the customer.

The correspondence data hub application 811 may also be configured to automatically implement the correspondence plan.

Thus, apparatus and methods to collect, combine, process, store, and analyze correspondence between customers and entities, generate approaches to convince a customer to switch to paperless correspondence, and implement those approaches are provided. Persons skilled in the art will appreciate that the present invention can be practiced by other than the described embodiments, which are presented for purposes of illustration rather than of limitation.

What is claimed is:

1. A correspondence data hub computer program product, the computer program product comprising executable instructions, the executable instructions when executed by a processor on a computer system:
receive two or more incoming correspondence files from a customer to an entity;
receive two or more outgoing correspondence files to the customer from the entity;
register each of the two or more incoming correspondence files and each of the two or more outgoing correspondence files;
record each registration within a database;
transfer each of the two or more incoming correspondence files and each of the two or more outgoing correspondence files to a pre-processing folder;
record each transfer within the database;
pre-process each of the incoming and outgoing correspondence files;
convert each of the incoming and outgoing correspondence files to a single format;
create a complete file for each of the incoming and outgoing correspondence files;
store each complete file within the database;
analyze each complete file; and
create a correspondence plan between the entity and the customer;
wherein:
pre-processing each correspondence file comprises capturing metadata;
each complete file comprises:
one correspondence file;
one pre-processed correspondence file; and
one formatted correspondence file;
the analysis comprises:
evaluating a source of each incoming correspondence file;
evaluating a type of each incoming correspondence file;
evaluating the metadata;
evaluating a location of where each incoming correspondence file was transmitted to the entity by the customer; and
evaluating a date and time of transmission of each incoming correspondence file; and
the correspondence plan communicates one or more benefits of paperless transactions to the customer.

2. The correspondence data hub computer program product of claim 1 wherein the single format is text.

3. The correspondence data hub computer program product of claim 1 wherein the single format is xml.

4. The correspondence data hub computer program product of claim 1 wherein a source of each of the incoming correspondence data files is one of:
a text message;
an email;
a phone call;
a video call;
a letter;
a fillable form; or
a chatbot conversation.

5. The correspondence data hub computer program product of claim 1 wherein the analysis uses one or more artificial intelligence/machine learning (“AI/ML”) algorithms.

6. The correspondence data hub computer program product of claim 1 wherein the correspondence plan is created by one or more artificial intelligence/machine learning (“AI/ML”) algorithms.

7. The correspondence data hub computer program product of claim 1 wherein the instructions transmit the correspondence plan to a system administrator.

8. The correspondence data hub computer program product of claim 1 wherein the instructions implement the correspondence plan.

9. The correspondence data hub computer program product of claim 8 wherein the correspondence plan is implemented by modifying a future outgoing correspondence file.

10. The correspondence data hub computer program product of claim 8 wherein the correspondence plan is implemented by checking all future outgoing correspondence files to the customer against the correspondence plan.

11. The correspondence data hub computer program product of claim 8 wherein when the customer agrees to one or more paperless transactions, the instructions modify the correspondence plan.

12. The correspondence data hub computer program product of claim 1 wherein the database is encrypted.

13. An apparatus for a correspondence data hub, the apparatus comprising:
a central server, the central server including:
a communication link;
a processor; and
a non-transitory memory configured to store at least:
a server operating system; and
a correspondence data hub application comprising:
an integrated data sourcing and provisioning module;
an automatic data quality check module; and
an integrated actionable insight module;
wherein:
the integrated data sourcing and provisioning module is configured to:
receive two or more incoming correspondence files from a customer to an entity;
receive two or more outgoing correspondence files to the customer from the entity;
register each of the two or more incoming correspondence files and each of the two or more outgoing correspondence files;
record each registration within a database;
transfer each of the two or more incoming correspondence files and each of the two or more outgoing correspondence files to the automatic data quality check module; and
record each transfer within the database;
the automatic data quality check module is configured to:
pre-process each of the incoming and outgoing correspondence files;
convert each of the incoming and outgoing correspondence files to a single format;
create a complete file for each of the incoming and outgoing correspondence files; and
store each complete file within the database; and
the integrated actionable insights module is configured to:
analyze each complete file; and
create a correspondence plan between the entity and the customer.

14. The apparatus of claim 13 wherein the integrated actionable insights module comprises one or more artificial intelligence/machine learning (“AI/ML”) algorithms.

15. The apparatus of claim 13 wherein the correspondence plan comprises one or more benefits to the customer of opting in to paperless transactions.

16. The apparatus of claim 15 wherein the correspondence plan is automatically implemented by the correspondence data hub application.

17. A method for incentivizing a customer to opt in to paperless transactions, the method comprising the steps of:
receiving, at an integrated data sourcing and provisioning module of a correspondence data hub application on a centralized server, two or more incoming correspondence files from the customer to an entity;
receiving, at the integrated data sourcing and provisioning module, two or more outgoing correspondence files to the customer from the entity;
registering, by the integrated data sourcing and provisioning module, each of the two or more incoming correspondence files and each of the two or more outgoing correspondence files;
recording, at a database, each registration;
transferring each of the two or more incoming correspondence files and each of the two or more outgoing correspondence files from the integrated data sourcing and provisioning module to an automatic data quality check module of the correspondence data hub application;
recording, by the correspondence data hub application each transfer within the database;
pre-processing, at the automatic data quality check module, each of the incoming and outgoing correspondence files;
converting, at the automatic data quality check module, each of the incoming and outgoing correspondence files to a single format;
creating, at the automatic data quality check module, a complete file for each of the incoming and outgoing correspondence files;
storing each complete file within the database;
analyzing, at an integrated actionable insights module of the correspondence data hub application, each complete file;
creating, at the integrated actionable insights module, a correspondence plan between the entity and the customer; and
automatically implementing, by the correspondence data hub application, the correspondence plan;
wherein:
each complete file comprises:
one correspondence file;
one pre-processed correspondence file; and
one formatted correspondence file; and
the correspondence plan comprises one or more benefits to the customer of opting in to paperless transactions.

18. The method of claim 17 wherein the database is located away from the central server.

19. The method of claim 18 wherein the correspondence data hub application uses one or more artificial intelligence/machine learning (“AI/ML”) algorithms in the steps of:
analyzing, at the integrated actionable insights module, each complete file;
creating, at the integrated actionable insights module, a correspondence plan between the entity and the customer; and
automatically implementing, by the correspondence data hub application, the correspondence plan.

20. The method of claim 17 wherein the customer is granted access to the correspondence data hub application by a system administrator.
